(19) United States
(12) Patent Application Publication
(10) Pub. No.: US 2018/0211260 A1
(43) Pub. Date: Jul. 26, 2018

(54) MODEL-BASED ROUTING AND PRIORITIZATION OF CUSTOMER SUPPORT TICKETS

(71) Applicant: LinkedIn Corporation, Sunnyvale, CA (US)

(72) Inventors: Yongzheng Zhang, San Jose, CA (US); Yi Zheng, Cupertino, CA (US); Chi-Yi Kuan, Fremont, CA (US); Rui Zhao, Mountain View, CA (US)

(73) Assignee: LinkedIn Corporation, Sunnyvale, CA (US)

(21) Appl. No.: 15/415,146

(22) Filed: Jan. 25, 2017

(51) Int. Cl. G06Q 30/00; G06N 99/00

(52) U.S. Cl. CPC G06Q 30/016; G06N 99/005

(57) ABSTRACT

The disclosed embodiments provide a system for processing data. During operation, the system obtains training data containing a first set of customer support tickets and a first set of categories assigned to the first set of customer support tickets by customer support agents. Next, the system uses the training data to produce a statistical model for classifying the customer support tickets into the categories. The system then uses the statistical model to classify a second set of customer support tickets into a second set of categories. Finally, the system generates output for routing the second set of customer support tickets to the customer support agents according to the second set of categories.

### RELATED APPLICATIONS

The subject matter of this application is related to the subject matter in a co-pending non-provisional application by inventors Yongzheng Zhang, Lutz Finger and Shaobo Liu, entitled “Topic Mining Using Natural Language Processing Techniques,” having Ser. No. 14/266,633, and filing date 30 Apr. 2014 (Attorney Docket No. LI-P0397.LNK.US).

The subject matter of this application is also related to the subject matter in a co-pending non-provisional application by inventors Vita Markman, Yongzheng Zhang, Craig Martell and Lutz T. Finger, entitled “Topic Extraction Using Clause Segmentation and High-Frequency Words,” having Ser. No. 14/807,674, and filing date 23 Jul. 2015 (Attorney Docket No. LI-P1563.LNK.US).

### BACKGROUND

### Field

The disclosed embodiments relate to techniques for managing customer support tickets. More specifically, the disclosed embodiments relate to techniques for performing model-based routing and prioritization of customer support tickets.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

In particular, text analytics may be used to model and structure text to derive relevant and/or meaningful information from the text. For example, text analytics techniques may be used to perform tasks such as categorizing text, identifying topics or sentiments in the text, determining the relevance of the text to one or more topics, assessing the readability of the text, and/or identifying the language in which the text is written. In turn, text analytics may be used to mine insights from large document collections, which may improve understanding of content in the document collections and reduce overhead associated with manual analysis or review of the document collections.

### BRIEF DESCRIPTION OF THE FIGURES

FIG. 1 shows a schematic of a system in accordance with the disclosed embodiments.

FIG. 2 shows a system for processing customer support tickets in accordance with the disclosed embodiments.

FIG. 3 shows a flowchart illustrating the processing of customer support tickets in accordance with the disclosed embodiments.

FIG. 4 shows a flowchart illustrating a process of updating a statistical model for classifying customer support tickets in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

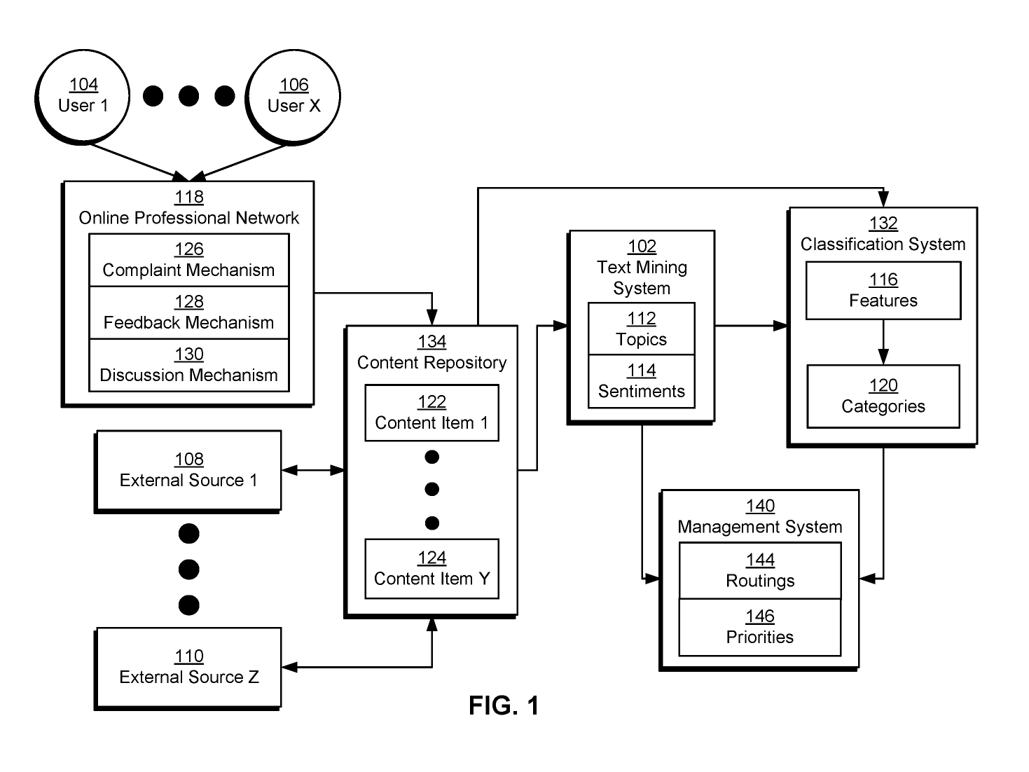

The disclosed embodiments provide a method, apparatus, and system for processing data. More specifically, the disclosed embodiments provide a method, apparatus, and system for performing model-based routing and prioritization of customer support tickets. As shown in FIG. 1, the customer support tickets may be included in a set of content items (e.g., content item 1 122, content item y 124) that are obtained from a set of users (e.g., user 1 104, user x 106) of an online professional network 118 or another application or service. The online professional network may allow the users to establish and maintain professional connections, list work and community experience, endorse and/or recommend one another, and/or search and apply for jobs. Employers and recruiters may use the online professional network to list jobs, search for potential candidates, and/or provide business-related updates to users.

As a result, content items associated with online professional network 118 may include posts, updates, comments, sponsored content, articles, and/or other types of unstructured data transmitted or shared within the online professional network. The content items may additionally include complaints provided through a complaint mechanism 126, feedback provided through a feedback mechanism 128, and/or group discussions provided through a discussion mechanism 130 of online professional network 118. For example, the complaint mechanism may allow users to file customer support tickets containing complaints or issues associated with use of the online professional network. Similarly, the feedback mechanism may allow the users to provide scores representing the users' likelihood of recommending the use of the online professional network to other users, as well as feedback related to the scores and/or suggestions for improvement. Finally, the discussion mechanism may obtain updates, discussions, and/or posts related to group activity on the online professional network from the users.

Content items containing unstructured data related to use of online professional network 118 may also be obtained from a number of external sources (e.g., external source 1 108, external source z 110). For example, user feedback for the online professional network may be obtained periodically (e.g., daily) and/or in real-time from reviews posted to review websites, third-party surveys, other social media websites or applications, and/or external forums. Content items from both the online professional network and the external sources may be stored in a content repository 134 for subsequent retrieval and use. For example, each content item may be stored in a database, data warehouse, cloud storage, and/or other data-storage mechanism providing the content repository.

In one or more embodiments, content items in content repository 134 include text input from users and/or text that is extracted from other types of data. As mentioned above, the content items may include posts, updates, comments, sponsored content, articles, and/or other text-based user opinions or feedback for a product such as online professional network 118 or some feature or aspect of online professional network 118. Alternatively, the user opinions or feedback may be provided in images, audio, video, and/or other non-text-based content items. A speech-recognition technique, optical character recognition (OCR) technique, and/or other technique for extracting text from other types of data may be used to convert such types of content items into a text-based format before or after the content items are stored in the content repository.

Because content items in content repository 134 represent user opinions, issues, and/or sentiments related to online professional network 118, information in the content items may be important to improving user experiences with online professional network 118 and/or resolving user issues with the online professional network. However, the content repository may contain a large amount of freeform and/or unstructured data, which may preclude efficient and/or effective review or handling of the data. For example, the content repository may contain thousands or millions of customer support tickets filed through complaint mechanism 126, which are handled by a much smaller number of customer support agents. The customer support tickets may also be routed to the customer support agents on a first-come first-serve basis instead of prioritizing the tickets by severity or matching the content or context of the tickets to customer support agents or teams that can most effectively resolve the tickets.

In one or more embodiments, the system of FIG. 1 includes functionality to automate and/or streamline the routing and/or prioritization of customer support tickets associated with online professional network. First, a text mining system 102 may automatically extract a set of topics 112 from the customer support tickets and/or other content items in content repository 134. To identify the topics, the text mining system may combine filtering of n-grams from clauses in content items with topic mining that utilizes natural language processing (NLP) techniques to generate part-of-speech (POS) tags for content items, as described in a co-pending non-provisional application by inventors Yongzheng Zhang, Lutz Finger and Shaobo Liu, entitled “Topic Mining Uisng Natural Lnguage Processing Techniques,” having Ser. No. 14/266,633, and filing date 30 Apr. 2014 (Attorney Docket No. LI-P0397.LNK.US), which is incorporated herein by reference.

As an alternative or addition to NLP-based extraction of topics 112, text mining system 102 may also separate the content items into clauses based on the presence of connective words and/or punctuation marks between adjacent groups of strings in a given content item. The topics may then be selected as n-grams in the clauses that do not include stop words and/or high-frequency words in pre-specified positions, such as at the beginning or the end of the n-grams. Clause-based topic extraction is described in a co-pending non-provisional application by inventors Vita Markman, Yongzheng Zhang, Craig Martell and Lutz T. Finger, entitled “Topic Extraction Using Clause Segmentation and High-Frequency Words,” having Ser. No. 14/807,674, and filing date 23 July 2015 (Attorney Docket No. LI-P1563.LNK.US), which is incorporated herein by reference.

Text mining system 102 may further select different topic mining techniques for use with different types of data. For example, NLP-based topic mining may be used with content items that contain well-formed, standard POS patterns, while filtering of n-grams from clauses in content items may be used with content items that contain incomplete or nonstandard sentences, such as social media posts.

Text mining system 102 may also identify a number of sentiments 114 associated with the customer support tickets. For example, the text mining system may use a statistical model to classify the sentiment of each ticket and/or portion (e.g., clause, sentence, field, etc.) of the ticket as positive, negative, neutral, or unknown. The text mining system may also characterize the strength of the sentiment using a confidence score, sub-classifications (e.g., strongly negative, negative, slightly negative, etc.), and/or other attributes.

Next, a classification system 132 may use a set of features 116 associated with the customer support tickets to classify the customer support tickets into a set of categories 120. For example, the features may include data used to generate the tickets, such as titles, descriptions, customer-selected categories, referral pages, applications, devices, and/or browsers. The features may also include data related to customers filing the tickets and/or customer support agents handling the tickets. The features may then be used to automatically categorize the tickets by the types of issues associated with the tickets.

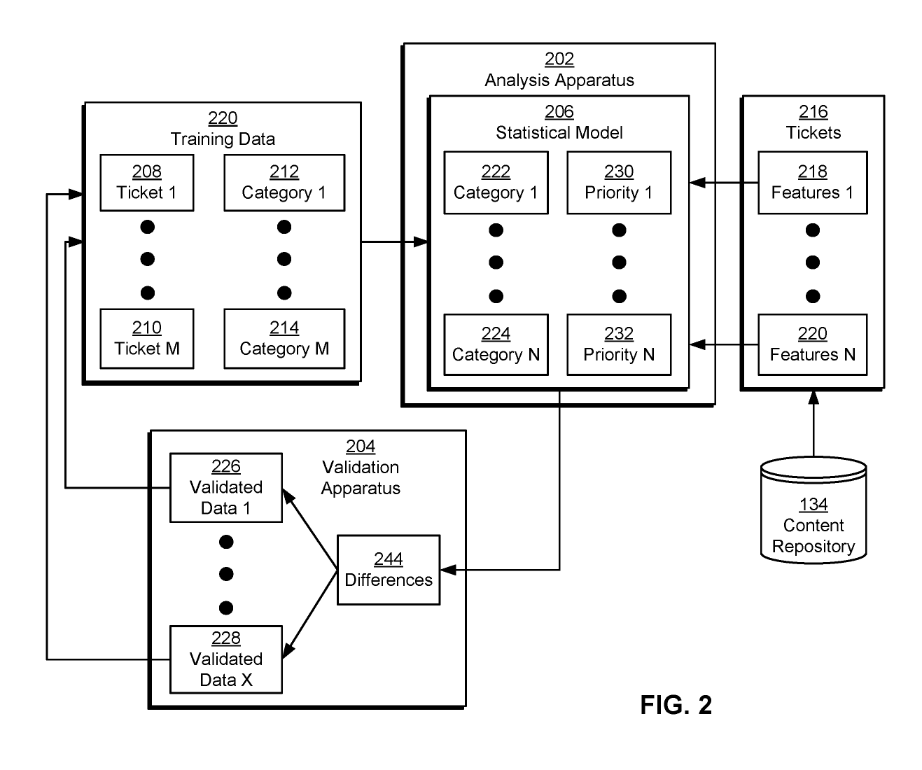

As discussed in further detail below with respect to FIG. 2, classification system 132 may use resolved customer support tickets that have been assigned to different categories 120 by customer support agents as training data for a statistical model. The classification system may then use the statistical model to classify open customer support tickets from content repository 134 into the categories and/or assign priorities 146 to the customer support tickets based on topics 112, sentiments 114, and/or other derived features.

A management system 140 may then generate output containing routings 144 of the customer support tickets to different customer support agents according to categories 120 into which the tickets are classified by classification system 120. For example, the management system may route or reroute tickets of a certain category to customer support agents with expertise or proficiency in handling issues or complaints related to the category. The management system may also produce output that applies priorities 146 to handling of the tickets by the customer service agents. For example, the management system may place higher-priority tickets (e.g., tickets associated with more urgent issues or stronger negative sentiment) ahead of lower-priority tickets (e.g., tickets associated with less urgent issues or less negative sentiment) in the queues of the customer service agents. Consequently, the system of FIG. 1 may streamline the implementation and use of customer-facing and/or customer support solutions for online professional network 118 and/or products offered by or within the online professional network.

In some embodiments, text mining system 102, classification system 132, content repository 134, and management system 140 are implemented as part of online professional network 118 (or some other online application or service). In other embodiments, one or more of these entities are implemented separately.

FIG. 2 shows a system for processing customer support tickets in accordance with the disclosed embodiments. More specifically, FIG. 2 shows a system for classifying customer support tickets 216, such as classification system 132 of FIG. 1. As shown in FIG. 2, the classification system includes an analysis apparatus 202 and a validation apparatus 204. Each of these components is described in further detail below.

Analysis apparatus 202 may create a statistical model 206 for classifying open customer support tickets 216 from content repository 134 into a set of categories (e.g., category 1 222, category n 224) and/or priorities (e.g., priority 1 230, priority n 232). For example, analysis apparatus 202 may create a support vector machine (SVM) that outputs a category for each customer support ticket and a measure of confidence in the outputted category as a representation of the ticket's priority.

As mentioned above, the categories may identify types of issues associated with use of an online professional network (e.g., online professional network 118 of FIG. 1) or other product. For example, the issues may pertain to company pages, groups, accounts/settings/permissions, advertising, applications, billing/payment/fees, contacts/connections/address book, inbox/invitations/messages, job listings, learning products, authentication, marketing, premium services, privacy/abuse, profiles, promotions, recommendations, restrictions, searching, and/or other products or features associated with the online professional network.

To create statistical model 206, analysis apparatus 202 may obtain training data 220 that includes a set of customer service tickets (e.g., ticket 1 208, ticket m 210) and a set of categories (e.g., category 1 212, category m 214) assigned to the tickets by customer service agents. For example, training data 220 may include a set of resolved customer service tickets, with each ticket assigned to the corresponding category by a customer service agent upon resolving the ticket. To increase the likelihood that the assigned categories are correct, the resolved tickets may be grouped, filtered, and/or otherwise processed so that tickets with similar topics and/or content are assigned to the same category.

Next, analysis apparatus 202 may use training data 220 to produce statistical model 206. For example, analysis apparatus 202 may train an SVM to have one or more maximum-margin hyperplanes that divide customer support tickets in training data 220 into two or more classes representing the corresponding categories according to features and/or attributes associated with the tickets.

After statistical model 206 is created from training data 220, analysis apparatus 202 may use statistical model 206 to generate a set of categories (e.g., category 1 222, category n 224) and/or priorities (e.g., priority 1 230, priority n 232) for additional customer support tickets 216 that are not in the original set of training data 220. For example, the analysis apparatus and/or another component of the classification system may obtain the tickets from content repository 134 and generate a set of features (e.g., features 1 218, features n 220) from each of the tickets. The analysis apparatus may then provide the features for each ticket as input to the statistical model, and statistical model 206 may output one or more categories (e.g., issue types) or priorities (e.g., levels of urgency or severity) for the ticket based on the inputted features.

In one or more embodiments, features inputted into statistical model 206 include ticket-specific features, customer-specific features, agent-specific features, and/or derived features. The ticket-specific features may be obtained and/or extracted from one or more fields of the tickets. For example, ticket-specific features for a given ticket may include a title, description (e.g., content of the ticket), customer-selected category (i.e., a category assigned to the ticket by the customer opening the ticket), referral page (e.g., a web page in the online professional network), application (e.g., feature or product in a mobile or web application), device (e.g., computer, mobile phone, tablet, type of device, etc.), and/or browser (e.g., type or version of web browser).

The customer-specific features may include attributes of the customer that opened the ticket. One or more customer-specific features may also be obtained from profile data from the online professional network, other social media, public records, and/or other sources of user data. For example, the customer-specific features may identify the customer type (e.g., enterprise, administrative, seat holder, recruiting, sales, marketing, premium, free, etc.), occupation, seniority, tenure at the online professional network, an engagement level with the online professional network (e.g., active or inactive), and/or an attribute associated with historic customer support tickets (e.g., number of tickets filed, number of resolved tickets, ticket categories, etc.) for the customer.

The agent-specific features may include attributes of the customer service agent to which the ticket is assigned. For example, the agent-specific features may include an expertise (e.g., in handling a type of customer or category of ticket), tenure (e.g., length of employment or experience), and/or language of the agent. The agent-specific features may also include a customer satisfaction score (CSAT) that is a rating, score, and/or other scale-based assessment of the responsiveness, communicativeness, ability to resolve issues, and/or other attributes of interaction with the customer service agent.

The derived features may include attributes that are obtained from analyzing the content of the ticket. For example, the derived features may include topics, sentiment, and/or specific products or categories found in the text content of the ticket.

After features for a customer support ticket are inputted into statistical model 206, a category and priority of the ticket may be obtained as output from the statistical model. For example, the statistical model may output an identifier for the category and a confidence score that is used as an indication of the priority of the ticket. The category and priority may then be used by a management system (e.g., management system 140 of FIG. 1) to generate output for routing and/or prioritizing the ticket according to the category and confidence score, as described above.

To improve the performance of statistical model 206, validation apparatus 204 may obtain a set of validated data (e.g., validated data 1 226, validated data x 228) for a subset of tickets 216. The validated data may be generated based on differences 244 between categories into which the tickets are classified by the statistical model and categories subsequently assigned to the tickets by the customer service agents (e.g., after the tickets are resolved). More specifically, when a difference is found in the assigned and classified categories for a ticket, the validation apparatus may use the features and/or content associated with the ticket to identify a root cause of the difference and resolve the difference. For example, the validation apparatus may display the difference and features in a graphical user interface (GUI). In turn, users may use the GUI to view the differences and features to identify and/or flag the differences as caused by agent error, lack of detail in the tickets, ambiguous text in the tickets, and/or other reasons. The users may also identify the correct category for each ticket, which may be the same as or different from the assigned or classified category of the ticket.

Validation apparatus 204 may also update one or more features of the ticket based on the corresponding root cause of the difference and/or the correct category of the ticket. Continuing with the previous example, a difference that is caused by agent error may be used to update a CSAT, expertise, and/or other agent-specific feature associated with the ticket. When the difference is caused by a lack of detail or ambiguous text in the ticket, a topic, sentiment, and/or other derived feature associated with the ticket may be updated to add detail or facilitate resolution of ambiguity in the ticket. The correct category of the ticket and updated features may then be included as validated data for the ticket.

Similarly, validation apparatus 204 may validate priorities assigned to the tickets by statistical model 208. Continuing with the previous example, the validation apparatus may display sentiments, topics, and/or priority associated with each ticket in the GUI, and the users may use user-interface elements in the GUI to change or confirm the displayed information. Changes to the sentiments, topics, and/or priority (e.g., levels of urgency, negative sentiment, and/or severity of the issues) from the users may then be included in validated data for the ticket, along with or separately from corrections to differences 244 and/or updated features associated with the corrections.

The validated data is provided as additional training data 220 that is used by analysis apparatus 202 to produce an update to statistical model 206. For example, the analysis apparatus may use validated categories, priorities, and/or features for a subset of tickets 216 to update an SVM for classifying customer support tickets into the categories and/or priorities. In turn, the validated data may improve the accuracy with which the SVM produces subsequent categories and/or priorities for additional customer support tickets 216 from content repository 134. Consequently, the system of FIG. 2 may include functionality to categorize and prioritize customer support tickets using the statistical model and continuously improve the performance of the statistical model based on user validations of the categories and/or priorities.

Those skilled in the art will appreciate that the system of FIG. 2 may be implemented in a variety of ways. First, analysis apparatus 202, validation apparatus 204, and/or data repository 134 may be provided by a single physical machine, multiple computer systems, one or more virtual machines, a grid, one or more databases, one or more filesystems, and/or a cloud computing system. The analysis apparatus and validation apparatus may additionally be implemented together and/or separately by one or more hardware and/or software components and/or layers.

Second, the functionality of statistical model 206 may be implemented using different techniques. In particular, categories and/or priorities for tickets 216 may be generated using an artificial neural network, Naïve Bayes classifier, Bayesian network, clustering technique, logistic regression technique, decision tree, and/or other type of machine learning model or technique. Moreover, the same statistical model or separate statistical models may be used to generate various subsets of categories and/or priorities for the tickets. For example, different instances of the statistical model may be used to produce different types of output (e.g., categories, priorities, etc.) related the tickets, or the same instance of the statistical model may be used to generate both a category and a priority for each ticket.

Finally, training data 220 for producing statistical model 206 may be generated and/or validated in various ways. As mentioned above, validated data used to update the statistical model may be obtained from users who correct differences 244 and the associated features within a GUI provided by validation apparatus 204. Validated data may also, or instead, be obtained via other mechanisms and used to train and/or track the performance of statistical model 206 in other ways. For example, analysis apparatus 202, validation apparatus 204, and/or other components of the classification system may obtain assigned categories in the training data and/or verify classified categories from statistical model 206 using feedback from multiple users or domain experts. In turn, the feedback may be used to generate a “vote” on the quality of the training data and/or statistical model output and allow the classification system to track the quality of the training data and/or statistical model output over time. The classification system may use the tracked quality to ensure that the accuracy of categories in subsequent training data and/or categories outputted by statistical model 206 increases over time. The classification system may also use the validated data to verify that the accuracy of the training data is higher than a threshold (e.g., 80-90%) before the statistical model is created from the training data and/or subsequently used to perform classification of one or more additional sets of customer support tickets 216.

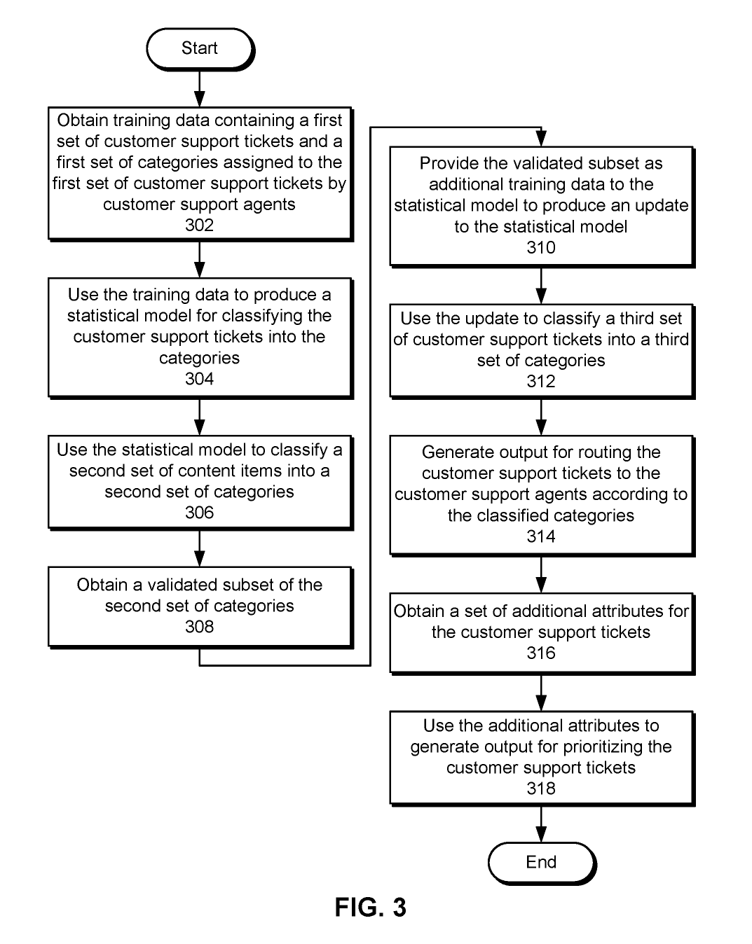

FIG. 3 shows a flowchart illustrating the processing of customer support tickets in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, training data containing a first set of customer support tickets and a first set of categories assigned to the first set of customer support tickets by customer support agents is obtained (operation 302). The categories may identify the types of issues associated with the tickets and/or otherwise characterize the issues or customers experiencing the issues. The training data may be obtained as resolved customer support tickets, along with categories assigned to the tickets by the customer support agents after the tickets are resolved.

Next, the training data is used to produce a statistical model for classifying the customer support tickets into the categories (operation 304). For example, the validated training data may be used to produce an SVM, Naïve Bayes classifier, logistic regression model, and/or other type of model that classifies the first set of customer support tickets into the first set of categories. To produce the statistical model, a set of features may be generated from each ticket and provided as input to the statistical model. The features may include ticket-specific features such as a title, description, customer-selected category, referral page, application, device, and/or browser. The features may also include customer-specific features such as a customer type, an occupation, a seniority, a tenure on an online professional network, an engagement level with the online professional network, and/or an attribute associated with historic customer support tickets. The features may further include agent-specific features such as an expertise of a customer service agent to which the customer support ticket is assigned, a tenure of the agent, a language of the agent, and/or a CSAT for the agent. Finally, the features may include derived features such as a topic, sentiment, and/or product or category extracted from the content of the ticket.

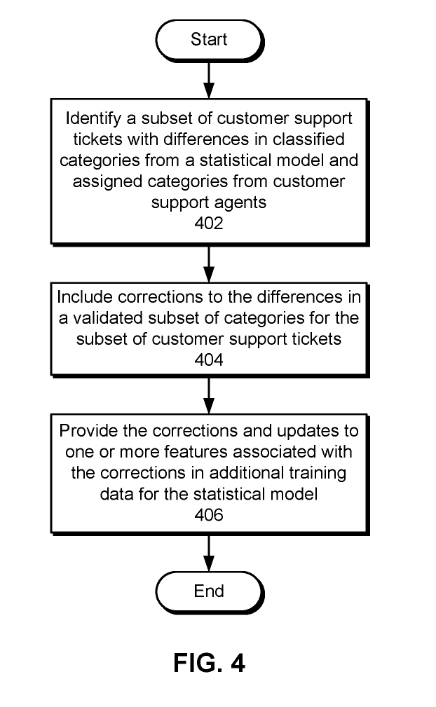

The statistical model is then used to classify a second set of customer support tickets into a second set of categories (operation 306). For example, the statistical model may be used to classify open customer service tickets into the categories. A validated subset of the second set of categories is also obtained (operation 308) and provided as additional training data to the statistical model to produce an update to the statistical model (operation 310), as described in further detail below with respect to FIG. 4. The update is then used to classify a third set of customer support tickets into a third set of categories (operation 312). Because the statistical model is updated using additional validated training data, the accuracy of the statistical model may increase over time.

Output for routing the customer support tickets to the customer support agents is generated according to the classified categories (operation 314). For example, the category into which an open ticket is assigned may be used to route or reroute the ticket to a customer service agent with experience or expertise in handling tickets of the corresponding issue type, customer type, and/or other type of category.

Finally, a set of additional attributes for the customer support tickets is obtained (operation 316) and used to generate output for prioritizing the customer support tickets (operation 318). For example, one or more topics and/or sentiments may be identified in each customer support ticket, and the customer support ticket may be assigned a severity, urgency, or other representation of priority based on the topics and/or sentiments. The assigned priority may be included as output with the ticket's category by the statistical model, or the priority may be assigned by another statistical model and/or mechanism. In turn, the priority may be used to order the tickets in queues for the customer support agents.

FIG. 4 shows a flowchart illustrating a process of updating a statistical model for classifying customer support tickets in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a subset of customer support tickets with differences in classified categories from a statistical model and assigned categories from customer support agents is identified (operation 402). For example, the subset of customer support tickets may be classified into a set of categories by the statistical model after the tickets are opened. Each ticket may be routed to a customer support agent based on the category into which the ticket is classified, and the customer support agent may assign the same category or a different category to the ticket upon resolution of the ticket. Thus, differences in the assigned and classified categories of the tickets may be identified after the tickets have been resolved.

Next, corrections to the differences are included in a validated subset of categories for the subset of customer support tickets (operation 404).

For example, the corrections may be made by users that select and/or specify a correct category and/or priority for each ticket. The corrections and updates to one or more features associated with the corrections are then provided in additional training data for the statistical model (operation 406). Continuing with the previous example, the users may specify one or more root causes of the difference in the assigned and classified categories for a ticket, and features of the ticket that are related to the cause(s) (e.g., customer-specific features, agent-specific features, derived features) may be automatically or manually updated. The updated feature(s), corrected categories, and/or corrected priorities may then be used to generate an update to the statistical model for use in categorizing subsequent sets of customer support tickets, as described above.

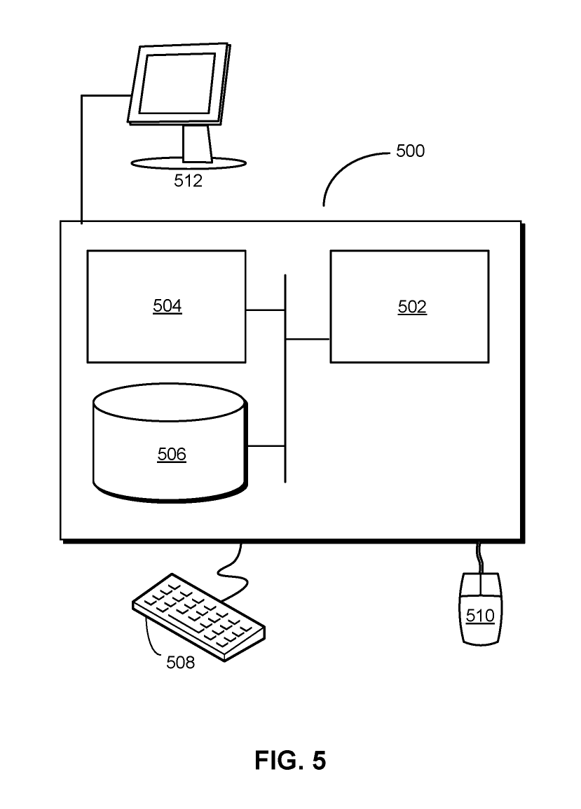

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system may include an analysis apparatus, a validation apparatus, and a management apparatus, some or all of which may alternatively be termed or implemented as a module, mechanism, or other type of system component. The analysis apparatus may obtain training data containing a first set of customer support tickets and a first set of categories assigned to the first set of customer support tickets by customer support agents. Next, the analysis apparatus uses the training data to produce a statistical model for classifying the customer support tickets into the categories. The analysis apparatus may then use the statistical model to classify a second set of customer support tickets into a second set of categories, and the management apparatus may generate output for routing the second set of customer support tickets to the customer support agents according to the second set of categories.

The validation apparatus may subsequently obtain a validated subset of the second set of categories for the second set of customer support tickets. Next, the analysis apparatus may provide the validated subset as additional training data to the statistical model to produce an update to the statistical model. The analysis apparatus may then use the update to classify a third set of customer support tickets into a third set of categories.

In addition, one or more components of computer system 500 may be remotely located and connected to the other components over a network. Portions of the present embodiments (e.g., analysis apparatus, validation apparatus, classification system, management system, text mining system, content repository, etc.) may also be located on different nodes of a distributed system that implements the embodiments. For example, the present embodiments may be implemented using a cloud computing system that obtains customer support tickets from a set of remote customers and classifies the tickets into a set of categories based on features of the tickets, customers, and/or customer support agents to which the tickets are assigned.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining training data comprising a first set of customer support tickets and a first set of categories assigned to the first set of customer support tickets by customer support agents;
using the training data to produce, by one or more computer systems, a statistical model for classifying the customer support tickets into the categories;
using the statistical model to classify, by the one or more computer systems, a second set of customer support tickets into a second set of categories; and
generating output for routing the second set of customer support tickets to the customer support agents according to the second set of categories.

2. The method of claim 1, further comprising:
obtaining a set of additional attributes for the second set of customer support tickets; and
using the additional attributes to generate output for prioritizing the second set of customer support tickets.

3. The method of claim 2, wherein the additional attributes comprise at least one of:
a topic; and
a sentiment.

4. The method of claim 1, further comprising:
obtaining a validated subset of the second set of categories for the second set of customer support tickets;
providing the validated subset as additional training data to the statistical model to produce an update to the statistical model; and
using the update to classify a third set of customer support tickets into a third set of categories.

5. The method of claim 1, wherein obtaining the validated subset of the second set of categories comprises:
identifying a subset of the second set of customer support tickets with differences in classified categories from the statistical model and assigned categories from the customer support agents; and
including corrections to the differences in the validated subset.

6. The method of claim 5, wherein providing the validated subset as additional training data to the statistical model comprises:
providing the corrections and updates to one or more features associated with the corrections in the additional training data.

7. The method of claim 1, wherein using the training data to produce the statistical model for classifying the customer support tickets into the categories comprises:
obtaining a set of features for a customer support ticket in the first set of customer support tickets; ands
providing the set of features as input to the statistical model.

8. The method of claim 7, wherein the set of features comprises at least one of:
a title;
a description;
a customer-selected category;
a referral page;
an application;
a device; and
a browser.

9. The method of claim 7, wherein the set of features comprises at least one of:
a customer type;
an occupation;
a seniority;
a tenure on an online professional network;
an engagement level with the online professional network; and
an attribute associated with historic customer support tickets.

10. The method of claim 7, wherein the set of features comprises at least one of:
an expertise of an agent to which the customer support ticket is assigned;
an tenure of the agent;
a language of the agent; and
a customer satisfaction score for the agent.

11. The method of claim 1, wherein:
the first set of customer support tickets comprises resolved customer support tickets; and
the second set of customer support tickets comprises open customer support tickets.

12. An apparatus, comprising:
one or more processors; and
memory storing instructions that, when executed by the one or more processors, cause the apparatus to:
obtain training data comprising a first set of customer support tickets and a first set of categories assigned to the first set of customer support tickets by customer support agents;
use the training data to produce a statistical model for classifying the customer support tickets into the categories;
use the statistical model to classify a second set of customer support tickets into a second set of categories; and
generate output for routing the second set of customer support tickets to the customer support agents according to the second set of categories.

13. The apparatus of claim 12, wherein the memory further stores instructions that, when executed by the one or more processors, cause the apparatus to:
obtain a set of additional attributes for the second set of customer support tickets; and
use the additional attributes to generate output for prioritizing the second set of customer support tickets.

14. The apparatus of claim 12, wherein the memory further stores instructions that, when executed by the one or more processors, cause the apparatus to:
obtain a validated subset of the second set of categories for the second set of customer support tickets;
provide the validated subset as additional training data to the statistical model to produce an update to the statistical model; and
use the update to classify a third set of customer support tickets into a third set of categories.

15. The apparatus of claim 14, wherein obtaining the validated subset of the second set of categories comprises:
identifying, from the second set of customer support tickets, a subset of customer support tickets with differences in classified categories from the statistical model and assigned categories from the customer support agents; and
including corrections to the differences in the validated subset.

16. The apparatus of claim 15, wherein providing the validated subset as additional training data to the statistical model comprises:
providing the corrections and updates to one or more features associated with the corrections in the additional training data.

17. The apparatus of claim 12, wherein using the training data to produce the statistical model for classifying the customer support tickets into the categories comprises:
obtaining a set of features for a customer support ticket in the first set of customer support tickets; and
providing the set of features as input to the statistical model.

18. The apparatus of claim 17, wherein the set of features comprises:
a ticket-specific feature;
a customer-specific feature; and
an agent-specific feature.

19. A system, comprising:
an analysis module comprising a non-transitory computer-readable medium comprising instructions that, when executed, cause the system to:
obtain training data comprising a first set of customer support tickets and a first set of categories assigned to the first set of customer support tickets by customer support agents;
use the training data to produce a statistical model for classifying the customer support tickets into the categories; and
use the statistical model to classify a second set of customer support tickets into a second set of categories; and
a management module comprising a non-transitory computer-readable medium comprising instructions that, when executed, cause the system to generate output for routing the second set of customer support tickets to the customer support agents according to the second set of categories.

20. The system of claim 19, further comprising:
a validation module comprising a non-transitory computer-readable medium comprising instructions that, when executed, cause the system to obtain a validated subset of the second set of categories for the second set of customer support tickets,
wherein the non-transitory computer-readable medium of the analysis module further comprises instructions that, when executed, cause the system to:
provide the validated subset as additional training data to the statistical model to produce an update to the statistical model; and
use the update to classify a third set of customer support tickets into a third set of categories.
